(19) United States
(12) Patent Application Publication
(10) Pub. No.: US 2026/0011494 A1
(43) Pub. Date: Jan. 8, 2026

(54) LAMINATED CERAMIC CAPACITOR

(71) Applicant: TAIYO YUDEN CO., LTD., Tokyo (JP)

(72) Inventor: Kotaro MIZUNO, Tokyo (JP)

(21) Appl. No.: 19/329,153

(22) Filed: Sep. 15, 2025

Related U.S. Application Data
(63) Continuation of application No. PCT/JP2024/003777, filed on Feb. 5, 2024.

(30) Foreign Application Priority Data
Mar. 16, 2023 (JP) 2023-042421

(51) Int. Cl. H01G 4/008; H01G 2/06; H01G 4/12; H01G 4/232; H01G 4/248; H01G 4/30

(52) U.S. Cl. CPC H01G 4/008; H01G 4/12; H01G 4/232; H01G 4/248; H01G 4/30; H01G 2/06

(57) ABSTRACT

A laminated ceramic capacitor includes a body, first and second external electrodes, and a first intermediate layer. The body includes first and second internal electrode layers, a dielectric layer disposed between the first and second internal electrode layers in a first direction, and a first intermediate layer. The first internal electrode layer contains a main component metal element and an element X different from the main component metal element. The first intermediate layer is disposed between the first internal electrode layer and the dielectric layer and contains the element X at a concentration 1.2 or more times a concentration of the element X in the first internal electrode layer. The first intermediate layer includes at least one first high concentration region where the element X is present at a concentration 1.5 or more times an average concentration of the element X in the entire first intermediate layer.

### CROSS-REFERENCE TO RELATED APPLICATIONS

This is a continuation application of a PCT application No. PCT/JP2024/3777 filed on Feb. 5, 2024, which is based on and claims the benefit of priority from Japanese Patent Application serial No. 2023-042421 (filed on Mar. 16, 2023). The contents of the PCT and Japanese applications are hereby incorporated by reference in their entirety.

### TECHNICAL FIELD

The disclosure herein relates mainly to a laminated ceramic capacitor and a method of manufacturing the laminated ceramic capacitor. The disclosure herein also relates to a circuit module with the laminated ceramic capacitor and an electronic device with the circuit module.

### BACKGROUND

The miniaturization of electronic devices has created a demand for increased capacitance in laminated ceramic capacitors, which are mounted in electronic devices, without an increase in the size of the capacitors. By reducing the thicknesses of the dielectric and internal electrode layers provided in the laminated ceramic capacitors, their capacitance can be increased without increasing the size of the capacitors.

However, thinner dielectric layers may lead to degraded insulation reliability of the laminated ceramic capacitors. To improve the insulation reliability, it has been proposed to add to the internal electrode layers metal elements that are different from the main component metal element. For example, International Publication No. 2012/111592 discloses that laminated ceramic capacitors with improved insulation reliability can be provided by adding Sn to the internal electrode layers, which are principally made of Ni. International Publication No. 2014/024538 discloses that laminated ceramic capacitors can exhibit improved insulation reliability by having Sn concentrated layers in the internal electrode layers, which are mainly composed of Ni. The Sn concentrated layers are located in the vicinity of the interfaces between the dielectric layers and the internal electrode layers.

Japanese Patent Application Publication No. 2003-7562 (“ the '562 Publication”) discloses a laminated ceramic capacitor including intermediate layers containing a metal element such as Au between dielectric layers and internal electrode layers. According to the disclosure of the '562 Publication, the insulation reliability of the laminated ceramic capacitors can be improved since the intermediate layers can increase the height of the Schottky barrier between the dielectric layers and the internal electrode layers.

The inventor of the present application has discovered that presence of intermediate layers with a concentrated secondary element between the internal electrode layers and the dielectric layers may inadvertently result in reduction in bonding strength between the internal electrode layers and the dielectric layers.

### SUMMARY

It is an object of the present disclosure to solve or alleviate at least part of the drawback mentioned above. Particularly, it is an object of the present disclosure to prevent a decrease in bonding strength between internal electrode layers and dielectric layers that is caused by intermediate layers containing a concentrated secondary element. The various inventions disclosed herein may be collectively referred to as “the invention”.

Other objects of the disclosure will be made apparent through the entire description in the specification. The invention disclosed herein may also address drawbacks other than that grasped from the above description. When an advantageous effect of an embodiment is described herein, the advantageous effect suggests an object of the invention corresponding to the embodiment.

An aspect of the present disclosure includes a laminated ceramic capacitor including a body, a first external electrode, a second external electrode and a first intermediate layer. In one aspect, the body includes a first internal electrode layer, a second internal electrode layer, a dielectric layer and a first intermediate layer. The first internal electrode layer contains a main component metal element and an element X different from the main component metal element. The dielectric layer is disposed between the first internal electrode layer and the second internal electrode layer in a first direction. The first intermediate layer is disposed between the first internal electrode layer and the dielectric layer and contains the element X at a concentration 1.2 or more times a concentration of the element X in the first internal electrode layer. The first external electrode is provided on the body so as to be electrically connected to the first internal electrode layer. The second external electrode is provided on the body so as to be electrically connected to the second internal electrode layer. The first intermediate layer includes, at a first cut plane orthogonal to the first direction, at least one first high concentration region where the element X is present at a concentration 1.5 or more times an average concentration of the element X in the entire first intermediate layer.

### ADVANTAGEOUS EFFECTS

One embodiment of the disclosure can prevent a decrease in bonding strength between internal electrode layers and dielectric layers that is caused by an added element.

### BRIEF DESCRIPTION OF THE DRAWINGS

FIG. 1 is a perspective view schematically showing a laminated ceramic capacitor according to one embodiment of the disclosure.

FIG. 2 is a sectional view schematically showing a section of the capacitor of FIG. 1 along the line I-I.

FIG. 3 is an enlarged sectional view showing, on an enlarged scale, a part (region A) of the section shown in FIG. 2.

FIG. 4 is an enlarged sectional view showing, on an enlarged scale, a part (region B) of the section shown in FIG. 2.

FIG. 5 is an enlarged sectional view showing, on an enlarged scale, a part (region C) of the section shown in FIG. 2.

FIG. 6 shows a two-dimensional concentration map for a surface parallel to a LT plane, which is obtained by reconstructing a three-dimensional secondary-element concentration map that is acquired through three-dimensional atomic probe analysis.

FIG. 7 shows a two-dimensional concentration map for a surface parallel to a LW plane, which is obtained by reconstructing a three-dimensional secondary-element concentration map that is acquired through three-dimensional atomic probe analysis.

FIG. 8 shows an example of a line profile obtained by EDS mapping.

FIG. 9 is a flowchart showing a flow of a manufacturing method of a laminated ceramic capacitor according to one embodiment of the disclosure.

### DESCRIPTION OF THE PREFERRED EMBODIMENTS

Various embodiments of the disclosure will be described hereinafter with reference to the appended drawings. Throughout the drawings, the same components are denoted by the same or like reference numerals. For convenience of explanation, the drawings are not necessarily drawn to scale. The following embodiments of the disclosure do not limit the scope of the claims. The elements included in the following embodiments are not necessarily essential to solve the problem addressed by the invention.

For convenience of explanation, each of the drawings may show the L axis, the W axis, and the T axis orthogonal to one another. In this specification, the dimensions, arrangement, shape, and other features of each component of a laminated ceramic capacitor 1 may be described with reference to the L, W, and T axes.

### (1) LAMINATED CERAMIC CAPACITOR 1

### (1-1) Basic Structure of Laminated Ceramic Capacitor 1

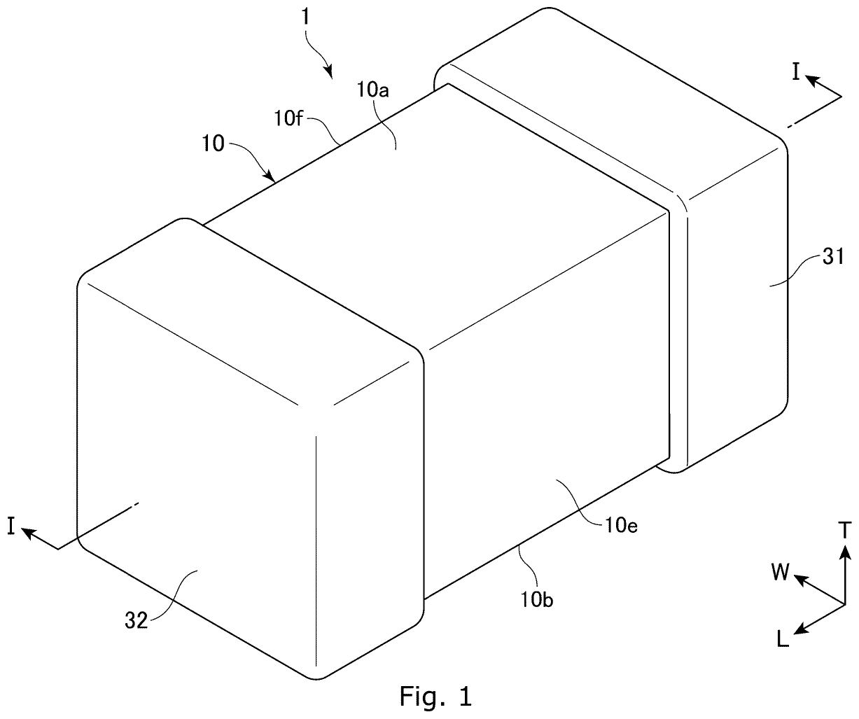

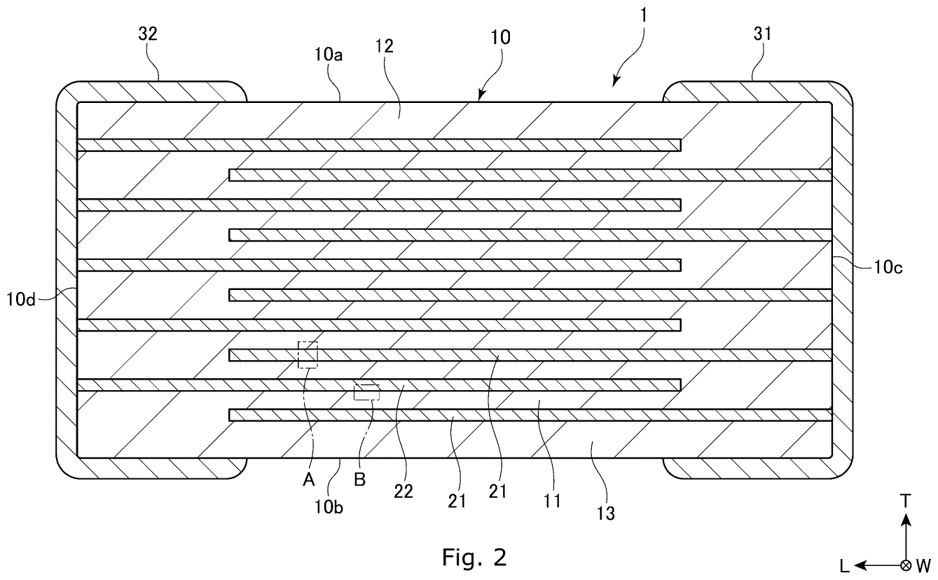

Referring to FIGS. 1 and 2, a description will now be given of the basic structure of a laminated ceramic capacitor 1 according to a first embodiment. FIG. 1 is a perspective view showing the laminated ceramic capacitor 1 according to the first embodiment. FIG. 2 is a sectional view schematically showing a section of the laminated ceramic capacitor 1 along the line I-I.

The laminated ceramic capacitor 1 has a body 10, and a first external electrode 31 and a second external electrode 32 provided on the body 10. The first external electrode 31 is spaced apart from the second external electrode 32. In the example shown in FIG. 2, the first external electrode 31 is spaced apart from the second external electrode 32 in the L-axis direction.

The body 10 includes a plurality of dielectric layers 11, a plurality of first internal electrode layers 21, and a plurality of second internal electrode layers 22. A dielectric layer 11 is present between a first internal electrode layer 21 and a second internal electrode layer 22 adjacent to the first internal electrode layer 21. In this specification, the first internal electrode layers 21 and the second internal electrode layers 22 may be referred to collectively as “the internal electrode layers” when it is not necessary to distinguish the first internal electrode layers 21 and the second internal electrode layers 22 from each other.

The body 10 has a top surface 10a, a bottom surface 10b, a first end surface 10c, a second end surface 10d, a first side surface 10e, and a second side surface 10f. The outer surface of the body 10 is defined by the top surface 10a, the bottom surface 10b, the first end surface 10c, the second end surface 10d, the first side surface 10e, and the second side surface 10f.

The top surface 10a and the bottom surface 10b form the opposite ends of the body 10 in the height direction (T-axis direction). In other words, the top surface 10a and the bottom surface 10b are opposed to each other in the T-axis direction. The first end surface 10c and the second end surface 10d form the opposite ends of the body 10 in the length direction (L-axis direction). In other words, the first end surface 10c and the second end surface 10d are opposed to each other in the L-axis direction. The first side surface 10e and the second side surface 10f form the opposite ends of the body 10 in the width direction (W-axis direction). In other words, the first side surface 10e and the second side surface 10f are opposed to each other in the W-axis direction. The top surface 10a and the bottom surface 10b are separated from each other by a distance equal to the height of the body 10, the first end surface 10c and the second end surface 10d are separated from each other by a distance equal to the length of the body 10, and the first side surface 10e and the second side surface 10f are separated from each other by a distance equal to the width of the body 10.

The body 10 is composed of the dielectric layers 11, the first internal electrode layers 21, and the second internal electrode layers 22 stacked together along the lamination direction. In the illustrated embodiment, the dielectric layers 11, the first internal electrode layers 21, and the second internal electrode layers 22 are stacked together along the T-axis direction. The lamination direction may be along the Taxis, as shown in the drawings, or may be along the L or W axis. The dielectric layers 11 located at the opposite ends in the lamination direction may be referred to as cover layers.

In the illustrated embodiment, the body 10 is constituted by the dielectric layers 11, the first internal electrode layers 21, and the second internal electrode layers 22 stacked together along the T-axis direction. Therefore, the T-axis direction may be referred to as the lamination direction. An upper cover layer 12 may be provided on the top surface of the laminate. A lower cover layer 13 may be provided on the bottom surface of the laminate. The upper cover layer 12 and the lower cover layer 13 may be formed of the same material as the dielectric layers 11. The upper cover layer 12 and the lower cover layer 13 may be a part of the body 10.

Each of the first internal electrode layers 21 has one end led toward the outside of the body 10. The first internal electrode layer 21 is connected to the first external electrode 31 provided on the surface of the body 10. Each of the second internal electrode layers 22 has one end led toward the outside of the body 10. The second internal electrode layer 22 is connected to the second external electrode 32 provided on the surface of the body 10. In the illustrated embodiment, the first internal electrode layer 21 is led out from one end of the body 10 in the L-axis direction toward the outside of the body 10. The first internal electrode layer 21 is connected to the first external electrode 31 at one end of the body 10 in the L-axis direction. The second internal electrode layer 22 is led out from the other end of the body 10 in the L-axis direction toward the outside of the body 10. The second internal electrode layer 22 is connected to the second external electrode 32 at the other end of the body 10 in the L-axis direction. In the example shown in FIG. 2, the first and second internal electrode layers 21 and 22 are respectively led out through the first and second end surfaces 10c and 10d, which are opposed to each other, but the first and second internal electrode layers 21 and 22 can be led out through various surfaces of the body 10 in accordance with the locations and the shapes of the first and second external electrodes 31 and 32. For example, if both the first and second external electrodes 31 and 32 are located on the bottom surface 10b, both the first and second internal electrode layers 21 and 22 are led out through the bottom surface. The first and second external electrodes 31 and 32 may be located on any of the surfaces of the body 10 as long as they are separated from each other.

When voltage is applied between the first and second external electrodes 31 and 32, capacitance is generated between the first and second internal electrode layers 21 and 22.

As will be described below, first intermediate layers 41 are provided between the dielectric layers 11 and the first internal electrode layers 21, and second intermediate layers 42 are provided between the dielectric layers 11 and the second internal electrode layers 22. FIGS. 1 and 2, however, do not show the first and second intermediate layers 41 and 42. In this specification, the first intermediate layers 41 and the second intermediate layers 42 may be referred to collectively as “the intermediate layers” when it is not necessary to distinguish the first intermediate layers 41 and the second intermediate layers 42 from each other.

FIG. 2 shows five each of the first and second internal electrode layers 21 and 22 for simplicity of illustration, but the laminated ceramic capacitor 1 may include any number of layers stacked together. The laminated ceramic capacitor 1 may include, for example, 300 to 1000 layers formed of the first and second internal electrode layers 21 and 22. In other words, the number of stacked layers in the laminated ceramic capacitor 1 may be 300 to 1000.

The laminated ceramic capacitor 1 may be mounted on an electronic circuit board. The electronic circuit board having the laminated ceramic capacitor 1 mounted thereon may be referred to as a circuit module. Various electronic components other than the laminated ceramic capacitor 1 may also be mounted on the circuit module. The circuit module may be installed in various electronic devices. The electronic devices in which the circuit module can be installed include smartphones, tablets, game consoles, electrical components of automobiles, servers, and various other electronic devices.

In one aspect, the body 10 may be configured to have a rectangular parallelepiped shape. The term “rectangular parallelepiped” or “rectangular parallelepiped shape” used herein is not intended to mean solely “rectangular parallelepiped” in a mathematically strict sense. As described below, the corners and/or edges of the body 10 may be rounded. The dimensions and the shape of the body 10 are not limited to those specified herein.

In one aspect, the laminated ceramic capacitor 1 has a dimension in the L-axis direction (length) of 0.2 mm to 2.5 mm, a dimension in the W-axis direction (width) of 0.1 mm to 3.5 mm, and a dimension in the T-axis direction (height) of 0.1 mm to 3.0 mm. In one aspect, the length of the laminated ceramic capacitor 1 may be larger than the width thereof. In one aspect, the height of the capacitor 1 may be larger than the width thereof. In one aspect, the width of the capacitor 1 may be larger than the length thereof.

### (1-2) Dielectric Layer 11

The dielectric layers 11 contain as their main component an oxide represented by a chemical formula ABO₃. The oxide may have a perovskite structure. A component that is at least 50 wt % of the dielectric layers 11 with reference to the total mass of the dielectric layers 11 can be regarded as the main component of the dielectric layers 11. When the dielectric layers 11 contain 50 wt % or more of the oxide represented by the chemical formula ABO₃, the dielectric layers 11 can be considered to contain the oxide represented by the chemical formula ABO₃ as their main component. The dielectric layers 11 preferably contain at least 60 wt %, 70 wt %, 80 wt %, or 90 wt % of the oxide represented by the chemical formula ABO₃.

In the chemical formula ABO₃, “A” is at least one element selected from the group consisting of Ba (barium), Sr (strontium), Ca (calcium), and Mg (magnesium). In the chemical formula ABO₃, “B” is at least one element selected from the group consisting of Ti (titanium), Zr (zirconium), and Hf (hafnium). When the oxide represented by the chemical formula ABO₃ has a perovskite structure, the elements “A” and “B” are located at the A site and the B site of the perovskite structure, respectively. Examples of the oxides contained in the dielectric layers 11 as their main component include BaTiO₃ (barium titanate), CaZrO₃ (calcium zirconate), CaTiO₃ (calcium titanate), SrTiO₃ (strontium titanate), and MgTiO₃ (magnesium titanate).

The oxide contained in the dielectric layers 11 as the main component may be an oxide represented by the chemical formula Ba_{1-x-y}CaₓSr_{y}Ti_{1-z}Zr_{z}O₃ (0≤x≤1, 0≤y≤1, 0≤z≤1). Examples of this type of oxide include strontium barium titanate, calcium barium titanate, barium zirconate, barium zirconate titanate, calcium zirconate titanate, and calcium barium zirconate titanate.

The dielectric layers 11 may contain one or more additive elements in addition to the main component oxide. In one aspect, the one or more additive elements contained in the dielectric layers 11 are selected from the group consisting of Fe (iron), Ni (nickel), Mo (molybdenum), Nb (niobium), Ta (tantalum), W (tungsten), Mg (magnesium), Mn (manganese), V (vanadium), and Cr (chromium). The dielectric layers 11 may contain two or more of the above additive elements.

The dielectric layers 11 may contain oxides of rare earth elements in addition to the main component oxide. The oxides of rare earth elements contained in the dielectric layers 11 may be oxides of at least one rare earth element selected from the group consisting of Y (yttrium), Sm (samarium), Eu (europium), Gd (gadolinium), Tb (terbium), Dy (dysprosium), Ho (holmium), Er (erbium), Tm (thulium), and Yb (ytterbium). The dielectric layers 11 may contain oxides of two or more rare earth elements.

The dielectric layers 11 may contain yet another type of oxide. The dielectric layers 11 may contain oxides of at least one element selected from the group consisting of, for example, Co (cobalt), Ni (nickel), Li (lithium), B (boron), Na (sodium), K (potassium), and Si (silicon). The dielectric layers 11 may contain oxides of two or more of these elements.

The dielectric layers 11 may contain glass containing at least one element selected from the group consisting of Co, Ni, Li, B, Na, K, and Si.

In one aspect, the thickness (the dimension in the T-axis direction) of each dielectric layer 11 is 0.2 to 10 μm.

### (1-3) First Internal Electrode Layers 21 and Second Internal Electrode Layers 22

In one aspect, the first internal electrode layers 21 contain a base metal such as Ni (nickel), Cu (copper), and Sn (tin), as the main component thereof. A component that is at least 50 wt % of the first internal electrode layers 21 with reference to the total mass of the first internal electrode layers 21 can be regarded as the main component of the first internal electrode layers 21. The first internal electrode layers 21 preferably contain 60 wt % or more, 70 wt % or more, 80 wt % or more, or 90 wt % or more of the base metal as the main component thereof.

The first internal electrode layers 21 can contain a secondary element in addition to the main component metal element. The secondary element that can be contained in the first internal electrode layers 21 is one element or more than one element selected from the group consisting of, for example, As (arsenic), Au (gold), Co, Cr, Cu, Fe, In (indium), Ir (iridium), Mg, Os (osmium), Pd (palladium), Pt (platinum), Re (rhenium), Rh (rhodium), Ru (ruthenium), Se (selenium), Sn, Ge (germanium), Te (tellurium), W, Y (yttrium), Zn (zinc), Ag (silver), and Mo. The main component metal element and the secondary element are separate elements. For example, when the main component metal element is Ni, Sn can be employed as the secondary element, but when the main component metal element is Sn, Sn cannot be selected as the secondary element.

In one aspect, the internal electrode layers can contain 0.01 at % to 5 at % the secondary element. When the internal electrode layers contain two or more elements as the secondary element, the total concentration of these two or more elements is 0.01 at % to 5 at %.

The description of the components of the first internal electrode layers 21 also applies to the components of the second internal electrode layers 22.

In an aspect, the thickness (the dimension in the T-axis direction) of each first internal electrode layer 21 is 0.1 μm to 2 μm. In one aspect, the thickness of the first internal electrode layer 21 is preferably 0.4 μm or less. The description of the thickness of each first internal electrode layer 21 also applies to the thickness of each second internal electrode layer 22.

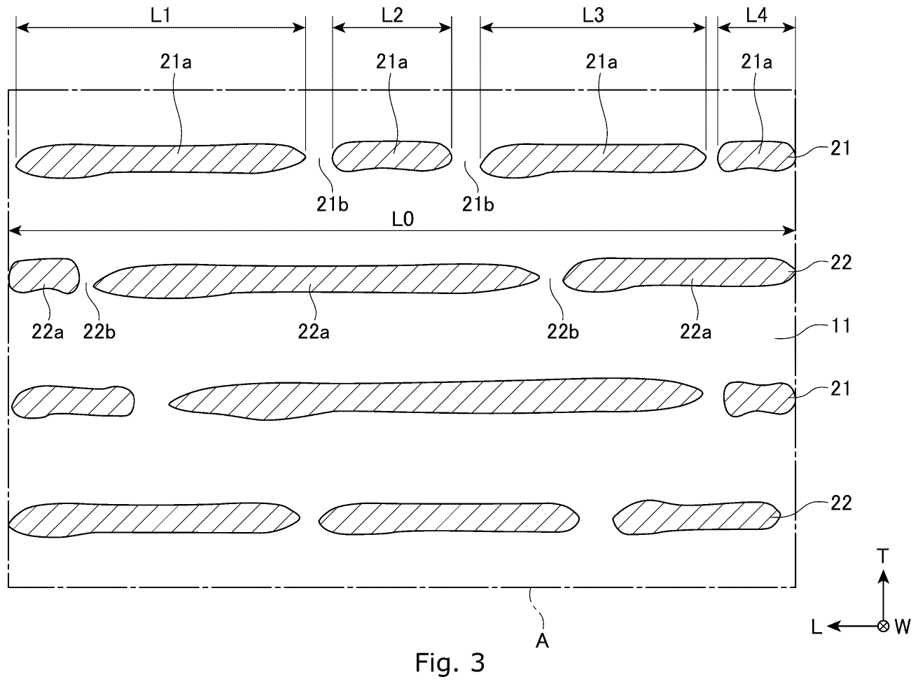

In one aspect, the continuity of the internal electrode layers in the laminated ceramic capacitor 1 is preferably 75% or higher. The continuity of the internal electrode layers will be further described with reference to FIG. 3. FIG. 3 is an enlarged sectional view showing, on an enlarged scale, a region A of the section of the body 10 shown in FIG. 2. The region A has a dimension LO of about 50 μm in the L-axis direction.

As shown in FIG. 3, each first internal electrode layer 21 includes a plurality of electrode regions 21a containing the main component metal element, and a plurality of non-electrode regions 21b between the electrode regions 21a. The non-electrode regions 21b are more insulating than the electrode regions 21a. The non-electrode regions 21b are occupied by, for example, oxides of the secondary element, a portion of the dielectric layers 11, and/or voids. As will be described in detail later, the first internal electrode layer 21 is formed by firing an internal electrode pattern containing the main component metal element. As sintering of the main component metal element progresses in this firing process, the shape of the sintered particles of the main component metal element approximates a sphere. During the firing of the internal electrode pattern, the sintered particles of the main component metal element take on a spherical form, resulting in residual voids between the spherical sintered particles, or intrusion of oxides of the secondary element and/or portions of the dielectric layers 11 into the voids. Thus, the non-electrode regions 21b are constituted by the voids left between the sintered particles of the main component metal element as a result of the firing process, and/or oxides of the secondary element and portions of the dielectric layers 11 that intrude into the voids.

The continuity of the first internal electrode layers 21 can be calculated as follows. First, the laminated ceramic capacitor 1 is polished so that an LT surface can be exposed as an observation surface. Next, the region A included in this observation surface is observed under a scanning electron microscope (SEM), and regions that appear bright in a resulting SEM image due to contrast difference are identified as the electrode regions 21a. The lengths of the electrode regions 21a are measured, and the measured lengths L1, L2, . . . , Ln are totaled. The total length of the electrode regions 21a in the region A is divided by the length L0 of the measured region (i.e., (L1+L2+ . . . . Ln)/L0), and the resulting value can be defined as the continuity of a single first internal electrode layer 21. The body 10 includes a plurality of first internal electrode layers 21, and the continuity can vary among the plurality of first internal electrode layers 21. Thus, ten different first internal electrode layers 21 can be selected, and the average of the continuities calculated for these selected first internal electrode layers 21 can be defined as the continuity of the first internal electrode layers 21 in the laminated ceramic capacitor 1.

Similar to the first internal electrode layers 21, the second internal electrode layers 22 can be each partitioned into electrode regions and non-electrode regions. Specifically, as shown in FIG. 3, each second internal electrode layer 22 includes a plurality of electrode regions 22a containing the main component metal element, and a plurality of non-electrode regions 22b between the electrode regions 22a. The continuity of the second internal electrode layers 22 is defined in the same way as that of the first internal electrode layers 21. Further, the average of the continuity of the first internal electrode layers 21 and the continuity of the second internal electrode layers 22 can be defined as the continuity of the internal electrode layers in the laminated ceramic capacitor 1.

In the laminated ceramic capacitor 1, capacitance is generated in the regions where the electrode regions 21a of the first internal electrode layers 21 face the electrode regions 22a of the second internal electrode layers 22 in the T-axis direction. Conversely, the non-electrode regions 21b and 22b do not contribute to the generation of capacitance. Therefore, in order to provide the laminated ceramic capacitor 1 with a high capacitance, the continuity of the internal electrode layers should desirably be high. In one aspect, the continuity of the internal electrode layers is 75% or higher. This provides the laminated ceramic capacitor 1 with a high capacitance.

### (1-4) First External Electrode 31 and Second External Electrode 32

In one aspect, the first and second external electrodes 31 and 32 are formed by applying a conductive paste to the body 10 and heating the conductive paste. The conductive paste can contain at least one substance from the group consisting of Ag, Pd, Au, Pt, Ni, Sn, Cu, W, Ti, and alloys of these.

### (1-5) First Intermediate Layer 41 and Second Intermediate Layer 42

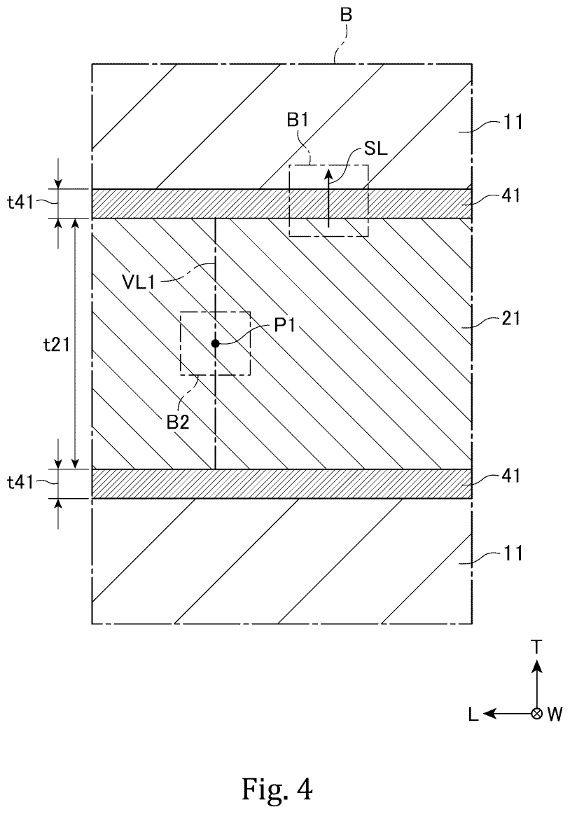

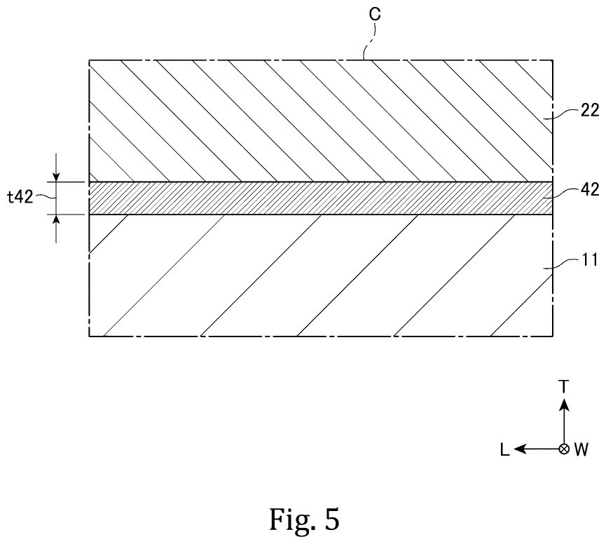

Next, with reference to FIGS. 4 and 5, a description is given of the first and second intermediate layers 41 and 42. The first intermediate layers 41 will now be described with reference to FIG. 4. FIG. 4 is an enlarged sectional view showing, on an enlarged scale, a region B of the section of the body 10 shown in FIG. 2. The region B includes a given one of the first internal electrode layers 21 provided in the body 10 and the dielectric layers 11 above and below the given first internal electrode layer 21. Stated differently, the region B extends from the dielectric layer 11 below the first internal electrode layer 21, over the first internal electrode layer 21, and to the dielectric layer 11 above the first internal electrode layer 21.

As shown in FIG. 4, the first intermediate layers 41 are provided between the dielectric layers 11 and the first internal electrode layers 21 in one embodiment. The first intermediate layers 41 contain an element that is the same as the secondary element contained in the first internal electrode layers 21. Specifically, the first intermediate layers 41 contain one element or more than one element selected from the group consisting of As, Au, Co, Cr, Cu, Fe, In, Ir, Mg, Os, Pd, Pt, Re, Rh, Ru, Se, Sn, Ge, Te, W, Y, Zn, Ag, and Mo. The concentration of the secondary element in the first intermediate layers 41 is higher than that in the first internal electrode layers 21. In other words, in the first intermediate layers 41, the secondary element is concentrated.

The first intermediate layers 41, which contain the concentrated secondary element, allow for higher Schottky barrier to be formed between the dielectric layers 11 and the first internal electrode layers 21. The higher Schottky barrier formed between the dielectric layers 11 and the first internal electrode layers 21 inhibits occurrence of insulation degradation associated with migration of oxygen defects toward the first internal electrode layers 21 and accumulation of those oxygen defects near the first internal electrode layers 21, and as a result, the insulation reliability of the laminated ceramic capacitor 1 can be enhanced. In other words, the service life of the laminated ceramic capacitor 1 can be extended.

The second intermediate layers 42 will now be described with reference to FIG. 5. FIG. 5 is an enlarged sectional view showing, on an enlarged scale, a region C of the section of the body 10 shown in FIG. 2. The region C includes a given one of the second internal electrode layers 22 provided in the body 10, and a dielectric layer 11 above or below the given second internal electrode layer 22. As shown in FIG. 5, the second intermediate layers 42 are provided between the dielectric layers 11 and the second internal electrode layers 22. The second intermediate layers 42 contain an element that is the same as the secondary element contained in the second internal electrode layers 22. Specifically, the second intermediate layers 42 contain one element or more than one element selected from the group consisting of As, Au, Co, Cr, Cu, Fe, In, Ir, Mg, Os, Pd, Pt, Re, Rh, Ru, Se, Sn, Ge, Te, W, Y, Zn, Ag, and Mo. The concentration of the secondary element in the second intermediate layers 42 is higher than that in the second internal electrode layers 22. In other words, in the second intermediate layers 42, the secondary element is concentrated. The second intermediate layers 42 allow for a higher Schottky barrier to be formed between the dielectric layers 11 and the second internal electrode layers 22. The higher Schottky barrier formed between the dielectric layers 11 and the second internal electrode layers 22 inhibits occurrence of insulation degradation associated with migration of oxygen defects toward the second internal electrode layers 22 and accumulation of those oxygen defects near the second internal electrode layers 22, and as a result, the insulation reliability of the laminated ceramic capacitor 1 can be enhanced. In other words, the service life of the laminated ceramic capacitor 1 can be extended.

The thickness t41 (dimension in the T-axis direction) of each first intermediate layer 41 is, for example, 0.2 nm to 3.0 nm. The lower limit of the thickness t41 of the first intermediate layer 41 may be 0.3 nm, 0.4 nm, or 0.5 nm. The upper limit of the thickness t41 of the first intermediate layer 41 may be 2.0 nm, 1.5 nm, or 1.3 nm. The thickness t42 of each second intermediate layer 42 may be comparable to the thickness t41 of the first intermediate layer 41.

In the illustrated embodiment, the body 10 includes the first intermediate layers 41 and the second intermediate layers 42. This configuration allows the Schottky barrier to be increased in both the regions between the dielectric layers 11 and the first internal electrode layers 21 and the regions between the dielectric layers 11 and the second internal electrode layers 22. In one aspect, it is possible that the body 10 includes the first intermediate layers 41 but does not include the second intermediate layers 42. In this case, the Schottky barrier between the dielectric layers 11 and the first internal electrode layers 21 can be increased. In one aspect, it is possible that the body 10 includes the second intermediate layers 42 but does not include the first intermediate layers 41. In this case, the Schottky barrier between the dielectric layers 11 and the second internal electrode layers 22 can be increased.

Each first intermediate layer 41 may entirely cover a corresponding first internal electrode layer 21. Each first intermediate layer 41 may cover only a portion of the corresponding first internal electrode layer 21. The first intermediate layers 41 preferably cover 80% or more of the entire top and bottom surfaces of the first internal electrode layers 21 to reduce leakage current. Likewise, each second intermediate layer 42 may entirely cover a corresponding second internal electrode layer 22. Each second intermediate layer 42 may cover only a portion of the corresponding second internal electrode layer 22. The second intermediate layers 42 preferably cover 80% or more of the entire top and bottom surfaces of the second internal electrode layers 22 to reduce leakage current.

As described above, the first intermediate layers 41 are a portion of the body 10 where the secondary element contained in the first internal electrode layers 21 is locally concentrated. According to one aspect, the first intermediate layers 41 contain the secondary element at a concentration 1.2 or more times that of the secondary element in the first internal electrode layers 21.

The following now describes the concentration of the secondary element in the first internal electrode layers 21. In one aspect, the concentration of the secondary element is quantified for some regions within the first internal electrode layers 21, and the average of the quantified concentration values can be used as the concentration of the secondary element in the first internal electrode layers 21. For example, FIG. 4 shows a region B2 near the middle in the T-axis direction (the lamination direction) of one of the first internal electrode layers 21. The region B2 is defined to include a midpoint P1 of an imaginary line segment VL1 in the T-axis direction, where the imaginary line segment VL1 extends from one end to the other end of the first internal electrode layer 21 along the T-axis. The region B2 is, for example, a square region with sides of 15 nm. The concentration of the secondary element in the region B2 can be taken as the concentration of the secondary element in the first internal electrode layers 21. A plurality of regions B2 may be defined in the first internal electrode layers 21, and the average of the concentrations of the secondary element in the respective regions B2 may be taken as the concentration of the secondary element in the first intermediate layers 21.

The concentration of the secondary element contained in the first internal electrode layers 21 means the atomic ratio (at %) of the secondary element to 100 at % of the main component metal element of the first internal electrode layers 21. For example, when the main component metal element of the first internal electrode layers 21 is Ni, the concentration of the secondary element means the atomic ratio (at %) of the secondary element to 100 at % Ni in the first internal electrode layers 21. As used herein, the concentration (at %) of the secondary element in the first internal electrode layers 21 is expressed as the atomic ratio of the secondary element to 100 at % of the main component metal element (e.g., Ni element) in the first internal electrode layers 21, unless otherwise specified. The concentration of the main component metal element measured in the region B2 can be taken as the concentration of the main component metal element in the first internal electrode layers 21.

The concentration of the secondary element in the first intermediate layers 41 can be quantified, for example, by three-dimensional atomic probe (3DAP) analysis. The concentration of the secondary element in the first intermediate layers 41 may be quantified by any other known analytical methods other than the three-dimensional atomic probe analysis. For example, the concentration of the secondary element in the first intermediate layers 41 may be quantified by secondary ion mass spectrometry (SIMS), TEM-EDS, or any other known analytical methods.

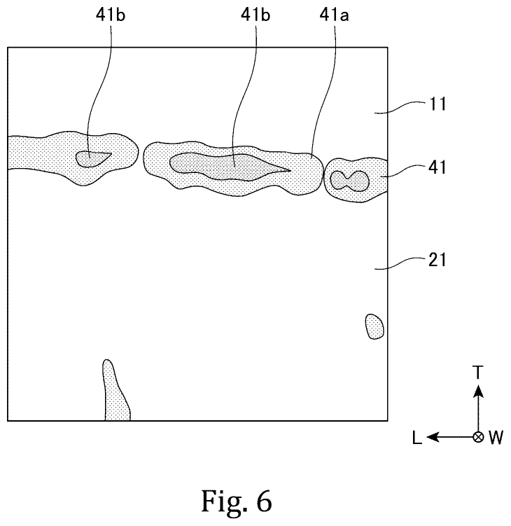

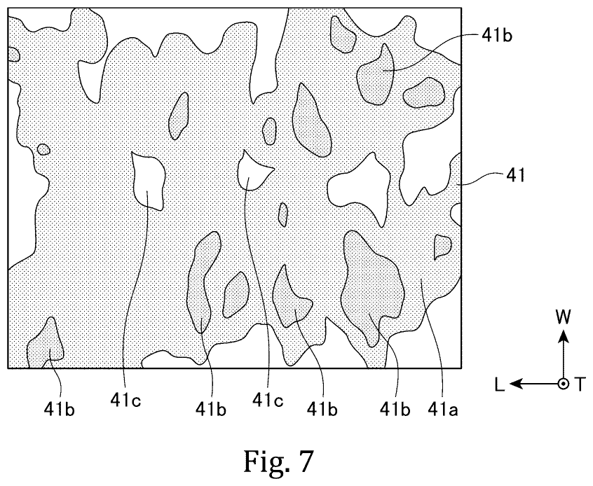

FIGS. 6 and 7 show examples of the concentration distribution of the secondary element in the first intermediate layers 41 that is quantified by three-dimensional atomic probe analysis. The two-dimensional concentration map shown in FIG. 6 is obtained by reconstructing a three-dimensional concentration map of the secondary element that is acquired through three-dimensional atomic probe analysis into a two-dimensional concentration map on a surface parallel to the LT plane. The two-dimensional concentration map shown in FIG. 7 is obtained by reconstructing a three-dimensional concentration map of the secondary element that is acquired through three-dimensional atomic probe analysis into a two-dimensional concentration map on a surface parallel to the LW plane.

As shown in FIGS. 6 and 7, the concentration map of the secondary element for an observation region including a first intermediate layer 41 is partitioned into a plurality of areas according to the concentration levels. FIGS. 6 and 7 show first regions 41a where the concentration of the secondary element is 1.2 times or more that in the first internal electrode layers 21. According to one aspect, the first intermediate layers 41 are set as the regions that contain the secondary element at a concentration 1.2 times or more that in the first internal electrode layers 21. Therefore, the first regions 41a define the outer peripheries of the first intermediate layers 41.

The three-dimensional atomic probe analysis can produce concentration maps not only for the secondary element, but also for the element constituting the main component oxide of the dielectric layers 11 and for the main component metal element of the first internal electrode layers 21. By referring to these concentration maps, a region having a high concentration of the element constituting the main component oxide can be identified as a dielectric layer 11, and a region having a high concentration of the main component metal element can be identified as a first internal electrode layer 21. In FIG. 6, the region above the first regions 41a on the plane of the drawing is a dielectric layer 11 with a high concentration of Ba and Ti, and the region below the first regions 41a on the plane of the drawing is a first internal electrode layer 21 with a high concentration of Ni.

In the concentration maps shown in FIGS. 6 and 7, first high concentration regions 41b are defined within the first regions 41a. The first high concentration regions 41b represent regions that contain the secondary element at a concentration 1.5 times or greater the average concentration of the secondary element in all the first intermediate layers 41. The average concentration of the secondary element in the first intermediate layers 41 means the average concentration of the secondary element in the regions identified as the first regions 41a. Stated differently, the concentration of the secondary element in the first high concentration regions 41b is 1.8 times or greater the concentration of the secondary element in the first internal electrode layers 21. The first high concentration regions 41b are regions within the first intermediate layers 41 where the secondary element is particularly concentrated.

In the concentration map shown in FIG. 7, first low concentration regions 41c are defined within the first regions 41a. The first low concentration regions 41c represent regions that contain the secondary element at a concentration 0.5 times or lower the average concentration of the secondary element in the first intermediate layers 41.

As described above, the first intermediate layers 41 are partitioned into the first regions 41a, first high concentration regions 41b, and first low concentration regions 41c according to the concentration levels of the secondary element. The first regions 41a may refer to any regions of the first intermediate layers 41 other than the first high concentration regions 41b and the first low concentration regions 41c.

The concentration of the secondary element in the first intermediate layers 41 may vary depending on the type of the element. When the secondary element is Au, the concentration of Au is 1 to 2.5 at % in the first regions 41a, 2.5-5 at % in the first high concentration regions 41b, and 0.1 to 1 at % in the first low concentration regions 41c, for example. When the secondary element is Fe, the concentration of Fe is 0.5 to 1 at % in the first regions 41a, 1 to 3.5 at % in the first high concentration regions 41b, and 0.1 to 0.5 at % in the first low concentration regions 41c, for example. When the secondary element is Sn, the concentration of Sn is 0.5 to 0.8 at % in the first regions 41a, 0.8 to 1.5 at % in the first high concentration regions 41b, and 0.1 to 0.5 at % in the first low concentration regions 41c, for example.

In the first intermediate layers 41, the atoms of the secondary element are stacked in the direction extending from the first internal electrode layers 21 to the dielectric layers 11 (that is, in the lamination direction, or in the T-axis direction with respect to the axes shown in the drawing). In the first intermediate layers 41, more secondary element atoms are stacked in the T-axis direction in the regions with a high concentration of the secondary element. For example, since the concentration of the secondary element is higher in the first high concentration regions 41b than in the first regions 41a, more secondary element atoms are stacked in the T-axis direction in the first high concentration regions 41b than in the first regions 41a. Since many secondary element atoms are stacked in the T-axis direction in the first high concentration regions 41b, the portions of the first intermediate layers 41 that correspond to the first high concentration regions 41b protrude toward the dielectric layers 11 and/or the first internal electrode layers 21 in the T-axis direction. In the first low concentration regions 41c, on the other hand, the first intermediate layers 41 are indented in the T-axis direction since a smaller number of atoms of the secondary element are stacked in the T-axis direction.

When the secondary element is Fe, the first regions 41a can contain 0.5 to 1 at % of Fe, while the first high concentration regions 41b can contain 1 to 3.5 at % of Fe as described above. When the Fe concentration is 1 at % in the first regions 41a and 3 at % in the first high concentration regions 41b, the first high concentration regions 41b protrude toward the dielectric layers 11 or first internal electrode layers 21 beyond the first regions 41a by a distance equivalent to two Fe atoms. Since the diameter of Fe atoms is about 0.25 nm, the first high concentration regions 41b protrude about 0.5 nm toward the dielectric layers 11 or the first internal electrode layers 21 beyond the first regions 41a.

Since the first intermediate layers 41 include the first high concentration regions 41b that contain a high concentration of the secondary element as described above, the first high concentration regions 41b are attributable to significantly uneven surfaces of the first intermediate layers 41. Since the uneven surfaces of the first intermediate layers 41 create an anchor effect, the first intermediate layers 41 including the first high concentration regions 41b can contribute to firm bonding between the dielectric layers 11 and the first internal electrode layers 21.

As shown in FIG. 7, a first intermediate layer 41 may include a plurality of first high concentration regions 41b spaced away from each other on a cut plane along the LW plane. When including more than one first high concentration regions 41b, the first intermediate layers 41 can produce an even stronger anchor effect and contribute to firmer bonding between the dielectric layers 11 and the first internal electrode layers 21.

When including the first low concentration regions 41c in addition to the first high concentration regions 41b, the first intermediate layers 41 have a more uneven surface and can produce an even stronger anchor effect. Therefore, by having the first high concentration regions 41b and the first low concentration region 41c, the first intermediate layers 41 can firmly bond the dielectric layers 11 and the first internal electrode layers 21. The first intermediate layers 41 do not need to have the low concentration regions 41c.

When the first internal electrode layers 21 and the first intermediate layers 41 contain two or more elements as the secondary element, the first regions 41a, the first high concentration regions 41b and the first low concentration regions 41c are distinguished from each other according to the total concentration levels of the two or more elements. For example, the total concentration of the two or more elements in the first regions 41a is 1.2 times or greater that in the first internal electrode layers 21. The total of the concentrations of the two or more secondary elements in the first high concentration regions 41b is 1.5 times or greater the total of the average concentrations of the respective secondary elements in all the first intermediate layers 41.

The foregoing description of the concentration of the secondary element in the first intermediate layers 41 also applies to the concentration of the secondary element in the second intermediate layers 42. Specifically, the second intermediate layers 42 contain the secondary element at a concentration 1.2 or more times that of the secondary element in the second internal electrode layers 22. The second intermediate layers 42 include second regions that contain the secondary element at a concentration 1.2 or more times that of the secondary element in the second internal electrode layers 22, and also include second high concentration regions that are within the second regions. The second high concentration regions in the second intermediate layers 42 contain the secondary element at a concentration 1.5 or more times the average concentration of the secondary element in all the second intermediate layers 42. The second high concentration regions in the second intermediate layers 42 are attributable to significantly uneven surfaces of the second intermediate layers 42. Since the uneven surfaces of the second intermediate layers 42 create an anchor effect, the second intermediate layers 42 including the second high concentration regions can contribute to firm bonding between the dielectric layers 11 and the second internal electrode layers 22.

The boundaries between the first intermediate layers 41 and the dielectric layers 11 or between the first intermediate layers 41 and the first internal electrode layers 21 can be identified using high-angle annular dark-field-scanning transmission electron microscopy (HAADF-STEM). The first and second internal electrode layers 21 and 22 have a higher density than the dielectric layers 11 and are thus observed as regions of relatively high brightness in HAADF-STEM.

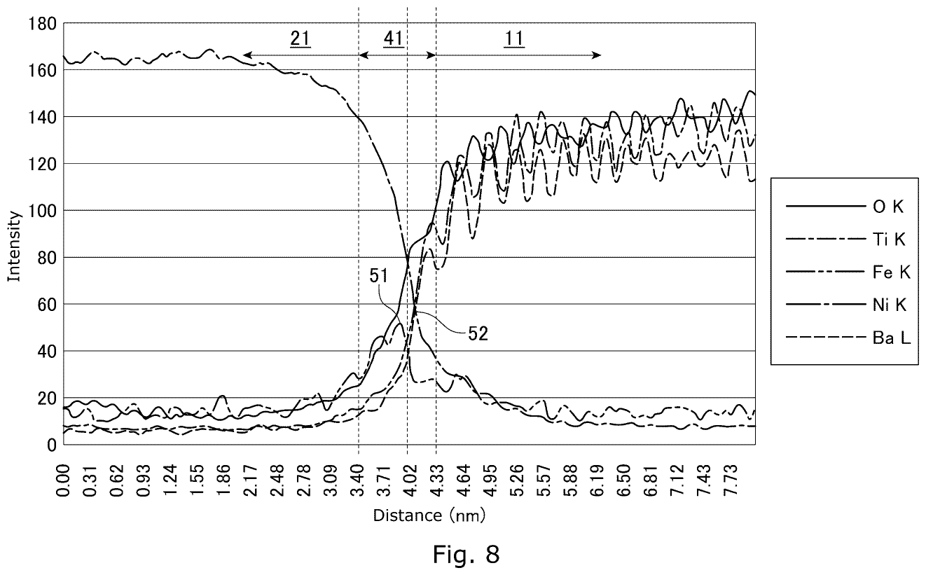

If the first intermediate layers 41 are not visible in electron microscope images, the presence of the first intermediate layers 41 can be confirmed as follows. An observation region extending from a first internal electrode layer 21 to a dielectric layer 11 is set on a section of the body 10 and subjected to Transmission Electron Microscope Energy Dispersive X-ray Spectroscopy (TEM-EDS) to obtain mapping data of the Fe element. The detection of the first intermediate layers 41 by TEM-EDS analysis can proceed, for example, as follows.
(1) An analysis specimen is prepared by thinly slicing the body 10 such that a surface parallel to the plane containing the T-axis (e.g., the LT plane) is exposed as an observation surface, and an observation region spanning from a first internal electrode layer 21 to a dielectric layer 11 is set on the observation surface of the thinly sliced analysis sample. Since the LT plane of the body 10 is shown in FIG. 4, the following description assumes that FIG. 4 shows the observation surface of the thinly sliced analysis specimen. FIG. 4 shows an observation region B1 as an example of the observation region for TEM-EDS analysis. The observation region B1 undergoes TEM-EDS, to obtain mapping data of the quantitative elements contained in the observation region B1 of the analysis specimen. The observation region B1 is, for example, a square region with sides of 15 nm. The quantitative elements include the elements contained in the main component oxide of the dielectric layers 11 (e.g., Ba, Ti, and O when the main component oxide is BaTiO₃), the main component metal of the first internal electrode layers 21 (for example, Ni), and the secondary element.
(2) Next, a line analysis is performed based on the obtained mapping data. Specifically, the mapping data of the quantitative elements are reconstructed along a scanning line SL that extends in the observation region B1 from the first internal electrode layer 21 to the dielectric layer 11, thereby creating line profiles for the respective quantitative elements. The length of the scanning line SL is 8 nm, for example. The length of the scanning line for obtaining the line profiles can be changed appropriately. FIG. 8 shows an example of the line profiles reconstructed along the scanning line SL from the mapping data obtained by TEM-EDS in the region B1 of the analysis specimen. The line profiles in FIG. 8 are an example of the graphs obtained as follows: an analysis specimen is prepared from the laminated ceramic capacitor 1 including the dielectric layers 11 that are principally composed of BaTiO₃ and the first internal electrode layers 21 containing Ni as the main component metal element and Fe as the secondary element, and subjected to TEM-EDS to obtain mapping data of the elements including Ba, Ti, O, Ni and Fe, and the mapping data is then reconstructed along a scanning line SL. In FIG. 8, the horizontal axis represents the detection position on the scanning line SL, and the vertical axis represents the detection intensities calculated based on the counts of Ba, Ti, O, Ni and Fe at the detection positions.
(3) If the peak of the line profile of Fe is located in the vicinity of the intersection where the line profile of the non-oxygen element of the main component oxide of the dielectric layers 11 (e.g., Ba) intersects with the line profile of the main component metal element of the first internal electrode layers 21 (hereinafter referred to as “profile intersection”), it can be determined that a first intermediate layer 41 exists in the laminated ceramic capacitor 1 from which the analysis specimen is taken. For example, if the distance between the position of the profile intersection and the position of the peak of the Fe line profile is equal to or less than a predetermined threshold value, the peak of the Fe line profile can be determined to be in the vicinity of the profile intersection. The predetermined threshold value can be, for example, 1 nm, 0.9 nm, 0.8 nm, 0.7 nm, 0.6 nm or 0.5 nm.

In the example shown in FIG. 8, the line profile of Ba in BaTiO₃ contained as the main component in the dielectric layers 11 intersects the line profile of Ni contained as the main component in the first internal electrode layers 21 at about 4.1 nm from the scanning start position. In other words, the profile intersection 52 where the Ba line profile intersects the Ni line profile is about 4.1 nm from the scanning start position. Here, the peak 51 of the Fe line profile is located at about 3.9 nm from the scanning start position. Since the peak 51 of the Fe line profile is located about 0.2 nm away from the profile intersection 52, which is less than the threshold value, it is determined that a first intermediate layer 41 exists in the region including the peak 51.

As described above, the first intermediate layers 41 contain the secondary element at a concentration 1.2 or more times that of the secondary element in the first internal electrode layers 21. The first high concentration regions 41b in the first intermediate layers 41 contain the secondary element at a concentration 1.5 or more times the average concentration of the secondary element in all the first intermediate layers 41. The concentration of the secondary element may be quantified using TEM-EDS in order to identify the first intermediate layers 41 and the first high concentration regions 41b.

### (2) MANUFACTURING METHOD OF LAMINATED CERAMIC CAPACITOR 1

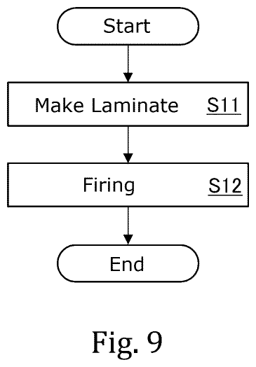

A description will now be given of one example of the manufacturing method of the laminated ceramic capacitor 1 with reference to FIG. 9. FIG. 9 is a flowchart showing a flow of a manufacturing method of a laminated ceramic capacitor according to one embodiment of the disclosure.

Here is a brief description of the manufacturing method shown in FIG. 9. In the step S11, a laminate is made as the precursor of the body 10. The laminate includes dielectric green sheets, which are the precursor of the dielectric layers 11, and internal electrode patterns, which are the precursor of the first and second internal electrode layers 21 and 22. The laminate may be made by alternately stacking dielectric green sheets having internal electrode patterns on the surfaces thereof which are the precursor of the first internal electrode layers 21, and dielectric green sheets having internal electrode patterns on the surfaces thereof which are the precursor of the second internal electrode layers 22. The internal electrode patterns contain the secondary element in addition to the main component metal element. In the next step S12, the laminate made in the step S11 is heated in a firing furnace to fire the dielectric green sheets and internal electrode patterns. In this manner, the laminated ceramic capacitor 1 is manufactured.

The following describes each of the steps shown in FIG. 9 in more detail. First, in the step S11, dielectric powder is wet-mixed with a binder such as polyvinyl butyral (PVB) resin, an organic solvent such as ethanol or toluene, and a plasticizer to obtain a slurry. This slurry is coated on a substrate film using, for example, the die coater or doctor blade method, and then the slurry coated on the substrate film is dried, to obtain a dielectric green sheet. The dielectric green sheets are the precursor of the dielectric layers 11.

The dielectric powder used as the raw powder of the dielectric green sheets is, for example, barium titanate powder. Barium titanate powder is synthesized by reacting titanium raw material such as titanium dioxide with barium raw material such as barium carbonate by a known method such as the solid phase method, the sol-gel method, or the hydrothermal method.

Next, internal electrode patterns are formed on the dielectric green sheets formed as described above. The internal electrode patterns are formed, for example, by printing a paste for the internal electrodes on the dielectric green sheets using screen printing or other known printing methods. When the internal electrode patterns are formed by screen printing, the paste for the internal electrodes is produced by kneading and mixing a metal powder, a binder resin, and a solvent by a three-roll mill. In other words, the paste for the internal electrodes is a binder resin containing a metal powder dispersed therein. The metal powder contained in the paste for the internal electrodes may be a powder mixture produced by mixing a powder of the main component metal element such as Ni, Cu, and Sn, which is the main component of the first and second internal electrode layers 21 and 22, with a powder containing the secondary element. The powder mixture is produced by mixing the main component metal powder with the secondary element powder so that the content ratio of the secondary element to 100 at % of the main component metal element is in the range of 0.01 to 5 at %. The organic binder used in the paste for the internal electrodes may be a cellulose-based resin such as ethyl cellulose or an acrylic resin such as butyl methacrylate. The internal electrode patterns formed on some of the dielectric green sheets are the precursor of the first internal electrode layers 21, and the internal electrode patterns formed on the others of the dielectric green sheets are the precursor of the second internal electrode layers 22.

Within the internal electrode patterns, the secondary element preferably has an uneven distribution. For an uneven distribution of the secondary element in the internal electrode patterns, the internal electrode paste for forming the internal electrodes is prepared in the following manner. A first type of dispersant is adsorbed on the main component metal powder, and a second type of dispersant, which is different from the first type of dispersant, is adsorbed on the secondary element powder. As a result, the main component metal powder and the secondary element powder, on which different types of dispersants adsorb, exhibit different levels of hydrophilicity (or hydrophobicity), so that the compatibility with the solvent is individually controlled for the main component metal powder and the secondary element powder. In this way, aggregates of the main component metal element and those of the secondary element can be formed in the solvent for the internal electrode patterns. The resulting paste for the internal electrodes can be used to form the internal electrode patterns, allowing the secondary element to be distributed unevenly within the internal electrode patterns.

The internal electrode patterns may be formed on the dielectric green sheets by the sputtering method. When the internal electrode patterns are formed by sputtering, the secondary element can also be distributed unevenly within the internal electrode patterns. For example, the nucleation rate or growth rate may be individually controlled for the main component metal element and the secondary element. This can lead to formation of internal electrode patterns, on the surfaces of the dielectric green sheets, where the secondary element forms an uneven surface or has an uneven distribution of concentrations. The method of forming the internal electrode patterns is not limited to those specified herein. The internal electrode patterns may be formed by various known methods, e.g., vacuum deposition, pulsed laser deposition (PLD), metal organic chemical vapor deposition (MO-CVD), metal organic decomposition (MOD), or chemical solution deposition (CSD).

As described above, a lamination unit having a dielectric green sheet and an internal electrode pattern formed on the surface of the dielectric green sheet is obtained. A predetermined number of lamination units are stacked together and thermo-compressed to form a laminate. The top layer and the bottom layer of the laminate may be formed of green sheets that do not have internal electrode patterns formed thereon.

Next, the laminate is diced into pieces to obtain chip-like laminates each being the precursor of the body 10. The chip-like laminates may be subjected to a degreasing process. The degreasing process may be performed in an N₂ atmosphere. The laminates having undergone the degreasing process may be coated with a metal paste by the dip method to form base electrode layers for the first and second external electrodes 31 and 32.

Next, in the step S12, each of the chip laminates produced in the step S11 is placed in a firing furnace, and fired in the firing furnace, thereby producing the laminated ceramic capacitor 1. In this firing process, the dielectric green sheets in the chip laminate are fired into the dielectric layers 11, and the internal electrode patterns are fired into the internal electrode layers (the first internal electrode layers 21 and the second internal electrode layers 22). During the firing process, the secondary element contained in the internal electrode patterns thermally diffuses toward the interfaces between the internal electrode patterns and the dielectric green sheets. In this way, the first and second intermediate layers 41 and 42, which contain the secondary element at a higher concentration than the internal electrode layers, are respectively formed between the dielectric layers 11 and the first internal electrode layers 21 and between the dielectric layers 11 and the second internal electrode layers 22, in the laminated ceramic capacitor 1.

During the firing process, an atmosphere that can allow uneven oxidation of the metal element, for example, a low oxygen atmosphere with an oxygen partial pressure of 10⁻⁹ to 10⁻⁷ atm is maintained in the firing furnace. If the firing is performed in a low oxygen atmosphere with an oxygen partial pressure of 10⁻⁹ to 10⁻⁷ atm, the oxygen concentration within the chip laminate fluctuates due to the influence of autogenous gases generated by decomposition of the thermal decomposition residue of the binder contained in the dielectric green sheets and internal electrodes. As a result, the main component metal element and secondary element contained in the internal electrode patterns repeatedly undergo uneven oxidation and reduction. Due to the repetitive uneven oxidation and reduction of the main component metal element and secondary element, the concentration distribution of the secondary element becomes significantly variable in the first and second intermediate layers 41 and 42 resulting from the firing.

An example of the temperature profile for the firing is now described. The temperature in the firing furnace is raised from the room temperature to an intermediate temperature at the rate of 200 to 300° C./h. The intermediate temperature is set at slightly lower than the sintering temperature of the main component metal element. When the main component metal element is Ni, the intermediate temperature is set at about 500 to 700° C. An example of the intermediate temperature is 600° C. The temperature is then increased at a fast rate from the intermediate temperature to a firing top temperature. The firing top temperature is, for example, 1200 to 1400° C. An example of the firing top temperature is 1300° C. The temperature increase rate is, for example, 20000 to 40000° C./h. An example of the temperature increase rate is 30000° C./h. By increasing the temperature at a high rate of about 20000 to 40000° C./h, the interfaces between the dielectric green sheets (the dielectric layers 11 after sintered) and the internal electrode patterns (the internal electrode layers after sintered) tend to be in a thermodynamically non-equilibrium state during the firing process, so that the concentration distribution in the first and second intermediate layers 41 and 42, which are formed between the dielectric layers 11 and the internal electrode layers, can become more uneven. The firing top temperature is maintained for a duration of within 10 seconds to prevent excessive sintering of the internal electrode layers. Cooling may start immediately after the firing top temperature is reached.

Processes not shown in the flowchart of FIG. 9 may be performed to produce the laminated ceramic capacitor 1. For example, the laminated ceramic capacitor 1 obtained through the firing in the step S12 may be subjected to re-oxidation treatment at 600° C. to 1000° C. in an N₂ gas atmosphere. A plating layer of Cu, Ni, Sn or the like may be provided on the surfaces of the first and second external electrodes 31 and 32. This plating layer can be formed by the electrolytic or electroless plating method.

### (3) EXAMPLES

The invention will now be further described in detail based on examples. The invention is not limited to the following examples.

### (3-1) Preparation of Samples

First, 14 different samples were prepared according to the manufacturing method shown in FIG. 9, as follows. A slurry was first obtained by wet-mixing barium titanate powder with polyvinyl butyral (PVB) resin, a solvent, and a plasticizer. The slurry was coated on a substrate film, and then the slurry coated on the substrate film was dried to obtain a dielectric green sheet. Next, a powder mixture was prepared by mixing Ni powder, which is the main component metal element, with the secondary element powder containing the secondary element listed in Table 1. The secondary element powder shown in Table 1 was weighed so that the ratio of the secondary element to 100 at % of Ni was the amount listed under “Amount of Secondary Element Added” in Table 1, and the weighed secondary element powder was mixed with the Ni powder. Next, the powder mixture was wet-mixed with polyvinyl butyral (PVB) resin, a solvent, and a plasticizer to obtain a slurry for the internal electrodes. Then, the slurry for the internal electrodes was printed on a part of the surface of each dielectric green sheet, to form an internal electrode pattern on the dielectric green sheet. In this way, a lamination unit was made. The lamination unit had the dielectric green sheet and the internal electrode pattern formed on the surface of the dielectric green sheet.

TABLE 1

| Sample | Secondary | Amount of Secondary |
|---|---|---|
| Number | Element | Element Added [at %] |
| 1 | Au | 0.3 |
| 2 | Fe | 0.5 |
| 3 | Au/Fe | 0.3/0.5 |
| 4 | Sn | 0.3 |
| 5 | Pt | 0.3 |
| 6 | Cu | 0.3 |
| 7 | Cr | 0.3 |
| 8 | Zn | 0.3 |
| 9 | Y | 0.3 |
| 10 | In | 0.3 |
| 11* | — | — |
| 12* | Au | 1.0 |
| 13* | Fe | 0.5 |
| 14* | Au/Fe | 1.0/0.5 |

As shown in Table 1, the secondary element is Au in sample 1 and Fe in sample 2. The secondary elements in the other samples are also listed in Table 1. Samples 3 and 14 contain two elements, Au and Fe, as the secondary element.

Next, 470 lamination units were stacked together to form a laminate, which was then diced into chip laminates. The chip laminates had the 1005 shape (length: 1.0 mm, width: 0.5 mm, height: 0.5 mm). Next, the chip laminates were degreased in an N₂ atmosphere. Next, the base layers of the external electrodes were formed on each of the chip laminates by applying metal paste to the degreased chip laminate by the dip method.

Next, the chip laminates obtained as described above, or the precursor of the samples, were put into the firing furnace, and the chip laminates were fired according to a predetermined temperature profile and under predetermined firing conditions. Specifically, the chip laminates for samples 1 to 10 underwent the following treatment. In a low-oxygen atmosphere with an oxygen partial pressure of 7.8×10⁻⁸ atm, the temperature inside the firing furnace was increased from the room temperature to 600° C. at a rate of 300° C./h, and then increased from 600° C. to 1300° C. at a rate of 30,000° C./h. Cooling was started immediately after the temperature reached 1300° C.

Samples 1 to 14 were obtained in this manner. In samples 1 to 14, the dielectric green sheets were fired into the dielectric layers, and the internal electrode patterns were fired into the internal electrode layers. The base layers formed on the chip laminates were fired into the external electrodes. Therefore, samples 1 to 14 are all laminated ceramic capacitors.

### (3-2) Verification of Internal Electrode Layer and Intermediate Layer

The thickness of the internal electrode layers was determined as follows. First, each sample was encapsulated in a resin, and the sample encapsulated in the resin was polished along a plane parallel to the lamination direction (e.g., the LT plane in FIG. 2) to expose a cross section parallel to the lamination direction. Next, an observation region (corresponding to the observation region A in FIG. 2) was identified in the exposed cross section of each sample using a field emission scanning secondary electron microscope (FE-SEM) at a magnification of 5,000 to 20,000 times, and the cross section of each sample was observed in the identified observation region. With a focus on ten layers of the dielectric layers and internal electrode layers within the observation region, the thickness of each internal electrode layer can be determined by calculating the difference between the average position of the ends in the T-axis direction of the ten dielectric layers and that of the ten internal electrode layers. The thickness of each internal electrode layer of samples 1 to 14 was calculated as described above. The results indicated that the thickness of each internal electrode layer was 0.4 μm for all samples.

The continuity of the internal electrode layers was calculated for each sample as follows. For each of the internal electrode layers included in each of the above observation regions, the electrode parts were identified based on the contrast difference, and the length of each of these electrode parts was measured. The continuity for each internal electrode layer was then calculated based on the measured lengths of the electrode parts. The average of the continuity values calculated for the respective internal electrode layers in the respective five observation regions was calculated, and this average was used as the continuity of the internal electrode layers in each sample. The continuity of the internal electrode layers thus calculated is listed in the column of “Continuity of Internal Electrode Layers” in Table 2. In all samples, high continuity values exceeding 80% were obtained.

Each of samples 1 to 14 was sliced using a focused ion beam (FIB) system so that an LT surface can be used as the observation surface, and a sliced analysis specimen with a thickness of 60 nm was taken from each of samples 1 to 14. Damage that appeared on the observation surface of the sliced specimen was removed as appropriate by Ar ion milling. Next, the sliced analysis specimen was placed in an EDS detector (JED-2300T available from JEOL Ltd.) in a TEM (TEM)EM-2100F available from JEOL Ltd.), and ten observation regions B1 (each corresponding to the observation region B1 in FIG. 4) of 15 nm square extending from an internal electrode layer to a dielectric layer were set and subjected to EDS analysis. Specifically, concentration maps representing the concentrations of the quantitative elements (Ba, Ti, O, Ni and the secondary element) in atomic ratio (at %) were obtained for each observation region B1 and reconstructed along a scanning line SL extending along the T-axis from the internal electrode layer to the dielectric layer within each observation region B1. In this way, the line profiles of the quantitative elements were obtained for each observation region B1. In the line profiles of samples 1 to 10 and samples 12 to 14, the peak of the secondary element appeared near the intersection of the Ba and Ni profiles similarly to what is shown in FIG. 8. For sample 11, no secondary element was detected. The results of the line analysis confirmed that an intermediate layer where the secondary element was concentrated was formed between a dielectric layer and an internal electrode layer in samples 1 to 10 and samples 12 to 14. The EDS was performed with the acceleration voltage being set at 200 kV and the electron beam diameter 1.5 nm for a duration of 3 hours.

In addition, ten observation regions B2 (each corresponding to the observation region B2 in FIG. 4) were identified. The observation regions B2 included the midpoint in the lamination direction (the T-axis direction) of the internal electrode layer (corresponding to the midpoint P1 in FIG. 4). The ten observation regions B2 in the internal electrode layers were subjected to EDS analysis to quantify the concentrations of the Ni element and the secondary element.

### (3-3) Analysis of Concentration of Secondary Element in Intermediate Layer

Next, the concentration of the secondary element at the interfaces between the internal electrode layers and the dielectric layers was analyzed for each sample except sample 11, to which no secondary element was added, as follows. To begin with, 10 specimens were taken from each sample prepared as described above. The specimens each had a size of 28 nm×26 nm in a plane parallel to the interfaces between the internal electrode layers and the dielectric layers and had a thickness of 4 nm in the direction perpendicular to the interfaces. In other words, the ten specimens were taken to include an intermediate layer (in the embodiment, the first or second intermediate layer 41 or 42) that is formed between an internal electrode layer and a dielectric layer and that contains the secondary element at an increased concentration. The concentration of the secondary element present in each specimen was then measured by performing three-dimensional atomic probe analysis to obtain a three-dimensional concentration map. The three-dimensional concentration map was then reconstructed into a two-dimensional concentration map on a surface (28 nm×26 nm) parallel to the LT plane of the specimen. Next, for each of the 10 specimens, a first region (corresponding to the first region 41b) was identified where the concentration of the secondary element in the two-dimensional concentration map was 1.2 or more times that in the internal electrode layer. The average concentration of the secondary element in the entire first region was then calculated. The first region was identified and the average concentration was calculated for each of the 10 specimens, and the average of the average concentration values calculated for the 10 respective specimens was used as the average concentration of the secondary element in the entire intermediate layer.

For each sample, the percentage by which the maximum concentration of the secondary element in the obtained two-dimensional concentration map exceeded the average concentration of the secondary element across the entire intermediate layer was also evaluated. In the “Max Concentration of Secondary Element” column of Table 2, the ratio (percentage) of the maximum concentration of the secondary element in the two-dimensional concentration map to the concentration of the secondary element in the entire intermediate layer is listed for each sample. For example, it was determined that samples 1 to 10 had a high concentration region where the maximum concentration of the secondary element in the obtained two-dimensional concentration map was 50% or more higher than the average concentration of the secondary element in the entire intermediate layer (i.e., the region where the concentration of the secondary element was 1.5 times the average concentration of the secondary element in the entire intermediate layer). For example, for sample 1, Table 2 shows that the maximum concentration of the secondary element in the two-dimensional concentration map is 150% of (i.e., 1.5 times) the average concentration across the entire intermediate layer. Samples 12 to 14 had no high concentration region where the highest concentration of the secondary element in the obtained two-dimensional concentration map was 50% or more higher than the average concentration of the secondary element in the entire intermediate layer. For samples 12 to 14, the highest concentration of the secondary element was only 10% to 20% higher than the average concentration of the secondary element in the entire intermediate layer.

Additionally, for each sample, the percentage by which the minimum concentration of the secondary element in the obtained two-dimensional concentration map fell below the average concentration of the secondary element across the entire intermediate layer was also evaluated. Table 2 shows in the “Min Concentration of Secondary Element” column the ratio (percentage) of the minimum concentration of the secondary element in the two-dimensional concentration map to the concentration of the secondary element in the entire intermediate layer for each sample. The results confirmed that samples 1 to 10 had a low concentration region where the lowest concentration of the secondary element in the obtained two-dimensional concentration map was 50% or more lower than the average concentration of the secondary element in the entire intermediate layer (the region where the concentration of the secondary element was 0.5 or less times the average concentration of the secondary element in the entire intermediate layer). For example, for sample 1, the results indicated that the minimum concentration of the secondary element in the two-dimensional concentration map was 50% of (i.e., 0.5 times) the average concentration in the entire intermediate layer. Samples 12 to 14 had no low concentration region where the minimum concentration of the secondary element in the obtained two-dimensional concentration map was 50% or more lower than the average concentration of the secondary element in the entire intermediate layer. For samples 12 to 14, the minimum concentration of the secondary element was only 10% to 20% lower than the average concentration of the secondary element in the entire intermediate layer.

The above results verified that the concentration distribution of the secondary element in the intermediate layer was highly uneven in samples 1 to 10, in other words, the surface of the intermediate layer was significantly rough in samples 1 to 10. According to the results, in samples 12 to 14, in contrast, the concentration distribution of the secondary element in the intermediate layer was less uneven than in samples 1 to 10, in other words, the surface of the intermediate layer in samples 12 to 14 had no significant protrusions and indentations and thus was a highly smooth surface.

### (3-5) HALT

One hundred pieces were selected for each of samples 1 to 14, and an accelerated life test (HALT) was performed on each of these selected pieces. In the accelerated life test, a voltage of 12 V/um was applied at 125° C. to the 100 pieces selected for each of samples 1 to 14, and the failure time was measured. The median of the failure time values measured for these 100 pieces is listed in the “HALT 50% Value (min)” column in Table 2. In light of the current market requirements, a HALT 50% value of 1000 hours or more can be considered to be an excellent lifetime.

### (3-6) Flexural Test

Next, 200 pieces were selected for each of samples 1 to 14, and a flexural test was performed on each of these selected pieces. The flexural test was conducted as follows. Each piece was mounted on a special substrate measuring 100 mm in length, 40 mm in width, and 1.6 mm in thickness. The substrate was then bent using an indenter, which applied pressure at a rate of 1.0 mm/sec to a depth of 3 mm. The center of the substrate served as the fulcrum (0 mm), and the force point was located ±45 mm from the center. Based on the test results, each piece was classified as conforming if no delamination of 10 μm or more in length was observed between an internal electrode layer and a dielectric layer when the indenter was pressed to a depth of 3 mm. Pieces exhibiting delamination exceeding this length were classified as defective. In the “Flexural Test Result” column of Table 2, the number of pieces determined to be defective out of the 200 pieces tested is listed for each sample.

TABLE 2

| | Continuity | Max | Min | HALT | |
|---|---|---|---|---|---|
| | of Internal | Concentration | Concentration | 50% | Flexural |
| Sample | Electrode | of Secondary | of Secondary | Value | Test |
| Number | Layers | Element | Element | (min) | Result |
| 1 | 88 | 150% | 50% | 2598 | 0/200 |
| 2 | 81 | 185% | 15% | 1980 | 0/200 |
| 3 | 84 | 180% | 20% | 3578 | 0/200 |
| 4 | 81 | 185% | 15% | 1770 | 0/200 |
| 5 | 87 | 150% | 50% | 1821 | 0/200 |
| 6 | 83 | 150% | 50% | 1630 | 0/200 |
| 7 | 90 | 180% | 20% | 1902 | 0/200 |
| 8 | 89 | 170% | 30% | 1402 | 0/200 |
| 9 | 83 | 150% | 50% | 1890 | 0/200 |
| 10 | 81 | 170% | 30% | 1630 | 0/200 |
| 11* | 91 | N/A | N/A | 212 | 0/200 |
| 12* | 92 | 110% | 90% | 3780 | 3/200 |
| 13* | 88 | 120% | 80% | 2895 | 2/200 |
| 14* | 89 | 120% | 80% | 6030 | 2/200 |

In Table 2, the samples not encompassed by the present invention (i.e., comparative examples) have an asterisk (*) added to the sample number. Specifically, samples 11 to 14 are comparative examples not encompassed by the present invention.

For samples 1 to 10, there were no pieces determined to be defective. For samples 12 to 14, two or three pieces were determined to be defective.

The above confirmed that the bonding strength between the internal electrode layers and the dielectric layers did not decline regardless the presence of the intermediate layers with concentrated secondary element between the internal electrode layers and the dielectric layers for samples 1 to 10, which had high concentration regions where the concentration of the secondary element was 50% or more higher than the average concentration of the secondary element in the entire intermediate layer in the two-dimensional concentration map. For samples 1 to 10, the continuity of the internal electrodes also exceeded the threshold of 75%, and the HALT 50% value also exceeded the market requirement of 1000 hours or more.

Table 1 does not show the results for the samples that were prepared using As, Co, Ir, Mg, Os, Pd, Re, Rh, Ru, Se, Sn, Te, W, Zn, Ag, Mo, and Ge as the secondary element. For these samples, two hundred pieces were also subjected to the above-mentioned flexural test, and no defective pieces were detected, the continuity of the internal electrodes exceeded the threshold of 75%, and the HALT 50% value also exceeded the market requirements of 1000 hours or more, if the two-dimensional concentration map had high concentration regions where the concentration of the secondary element was 50% or more higher than the average concentration of the secondary element across the intermediate layer.

### (4) NOTES

The dimensions, materials, and arrangements of the constituent elements described for the above various embodiments are not limited to those explicitly described for the embodiments, and these constituent elements can be modified to have any dimensions, materials, and arrangements within the scope of the present invention.

Constituent elements not explicitly described herein can also be added to the above-described embodiments, and it is also possible to omit some of the constituent elements described for the embodiments.

The words “first,” “second,” “third” and so on used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

The expression of “including” a constituent element used herein does not exclude other constituent elements but rather means that other constituent elements can be further included, as long as they are consistent with the invention.

### (5) ADDITIONAL EMBODIMENTS

Embodiments disclosed herein also include the following.

### Additional Embodiment 1

A laminated ceramic capacitor comprising:
a body having:
   a first internal electrode layer containing a main component metal element and an element X different from the main component metal element;
   a second internal electrode layer;
   a dielectric layer disposed between the first and second internal electrode layers in a first direction; and
   a first intermediate layer disposed between the first internal electrode layer and the dielectric layer, the first intermediate layer containing the element X at a concentration 1.2 or more times a concentration of the element X in the first internal electrode layer,
a first external electrode provided on the body so as to be electrically connected to the first internal electrode layer; and
a second external electrode provided on the body so as to be electrically connected to the second internal electrode layer,
wherein the first intermediate layer includes, at a first cut plane orthogonal to the first direction, at least one first high concentration region where the element X is present at a concentration 1.5 or more times an average concentration of the element X in the entire first intermediate layer.

### Additional Embodiment 2

The laminated ceramic capacitor of [Additional Embodiment 1], wherein the first intermediate layer further includes a first low concentration region where the element X is present a concentration 0.5 or less times the average concentration of the element X in the entire first intermediate layer.

### Additional Embodiment 3

The laminated ceramic capacitor of [Additional Embodiment 1] or [Additional Embodiment 2], wherein the first intermediate layer has, on the first cut plane, a plurality of first high concentration regions.

### Additional Embodiment 4

The laminated ceramic capacitor of any one of [Additional Embodiment 1] to [Additional Embodiment 3], wherein the element X is selected from the group consisting of As, Au, Co, Cr, Cu, Fe, In, Ir, Mg, Os, Pd, Pt, Re, Rh, Ru, Se, Sn, Ge, Te, W, Y, Zn, Ag, Mo, and Ge.

### Additional Embodiment 5

The laminated ceramic capacitor of any one of [Additional Embodiment 1] to

### Additional Embodiment 4

wherein the first internal electrode layer further contains an element Y, and
wherein, in the first high concentration region, a total of the concentration of the element X and a concentration of the element Y is 1.5 or more times a total of the average concentration of the element X and an average concentration of the element Y in the entire first intermediate layer.

### Additional Embodiment 6

The laminated ceramic capacitor of [Additional Embodiment 2], wherein, in the first low concentration region, the total of the concentration of the element X and the concentration of the element Y is 0.5 or less times the total of the average concentration of the element X and the average concentration of the element Y in the entire first intermediate layer.

### Additional Embodiment 7

The laminated ceramic capacitor of any one of [Additional Embodiment 1] to [Additional Embodiment 6], wherein the main component metal element is Ni.

### Additional Embodiment 8

The laminated ceramic capacitor of any one of [Additional Embodiment 1] to [Additional Embodiment 7], wherein the first internal electrode layer contains the element X at a concentration of 0.01 at % to 5 at %.

### Additional Embodiment 9

The laminated ceramic capacitor of any one of [Additional Embodiment 1] to [Additional Embodiment 8],
wherein the body further includes a second intermediate layer disposed between the second internal electrode layer and the dielectric layer in the first direction, the second intermediate layer containing the element X at a concentration 1.2 or more times a concentration of the element X in the second internal electrode layer, and
wherein the second intermediate layer includes, on the first cut plane, a second high concentration region where the element X is present at a concentration 1.5 or more times an average concentration of the element X in the entire second intermediate layer.

### Additional Embodiment 10

A circuit module including the laminated ceramic capacitor of any one of [Additional Embodiment 1] to [Additional Embodiment 9].

### Additional Embodiment 11

An electronic device including the circuit module of Additional Embodiment 10.

What is claimed is:

1. A laminated ceramic capacitor comprising:
a body having:
a first internal electrode layer containing a main component metal element and an element X different from the main component metal element;
a second internal electrode layer;
a dielectric layer disposed between the first and second internal electrode layers in a first direction; and
a first intermediate layer disposed between the first internal electrode layer and the dielectric layer, the first intermediate layer containing the element X at a concentration 1.2 or more times a concentration of the element X in the first internal electrode layer,
a first external electrode provided on the body so as to be electrically connected to the first internal electrode layer; and
a second external electrode provided on the body so as to be electrically connected to the second internal electrode layer,
wherein the first intermediate layer includes, at a first cut plane orthogonal to the first direction, at least one first high concentration region where the element X is present at a concentration 1.5 or more times an average concentration of the element X in the entire first intermediate layer.

2. The laminated ceramic capacitor of claim 1, wherein the first intermediate layer further includes a first low concentration region where the element X is present a concentration 0.5 or less times the average concentration of the element X in the entire first intermediate layer.

3. The laminated ceramic capacitor of claim 1, wherein the first intermediate layer has, on the first cut plane, a plurality of first high concentration regions.

4. The laminated ceramic capacitor of claim 1, wherein the element X is selected from the group consisting of As, Au, Co, Cr, Cu, Fe, In, Ir, Mg, Os, Pd, Pt, Re, Rh, Ru, Se, Sn, Te, W, Y, Zn, Ag, Mo, and Ge.

5. The laminated ceramic capacitor of claim 1,
wherein the first internal electrode layer further contains an element Y, and
wherein, in the first high concentration region, a total of the concentration of the element X and a concentration of the element Y is 1.5 or more times a total of the average concentration of the element X and an average concentration of the element Y in the entire first intermediate layer.

6. The laminated ceramic capacitor of claim 2, wherein, in the first low concentration region, the total of the concentration of the element X and the concentration of the element Y is 0.5 or less times the total of the average concentration of the element X and the average concentration of the element Y in the entire first intermediate layer.

7. The laminated ceramic capacitor of claim 1, wherein the main component metal element is Ni.

8. The laminated ceramic capacitor of claim 1, wherein the first internal electrode layer contains the element X at a concentration of 0.01 at % to 5 at %.

9. The laminated ceramic capacitor of claim 1,
wherein the body further includes a second intermediate layer disposed between the second internal electrode layer and the dielectric layer in the first direction, the second intermediate layer containing the element X at a concentration 1.2 or more times a concentration of the element X in the second internal electrode layer, and
wherein the second intermediate layer includes, on the first cut plane, a second high concentration region where the element X is present at a concentration 1.5 or more times an average concentration of the element X in the entire second intermediate layer.

10. A circuit module comprising the laminated ceramic capacitor of claim 1.

11. An electronic device comprising the circuit module of claim 10.
